(19) United States
(12) Patent Application Publication
(10) Pub. No.: US 2021/0004657 A1
(43) Pub. Date: Jan. 7, 2021

(54) SYSTEM, METHOD, AND COMPUTER PROGRAM FOR TRACKING STATUS OF ONE OR MORE INSPECTION PROCESSES IN CONNECTION WITH FOOD SPECIMENS

(71) Applicant: Kevin J Zilka, Los Gatos, CA (US)

(72) Inventor: Kevin J Zilka, Los Gatos, CA (US)

(21) Appl. No.: 16/921,726

(22) Filed: Jul. 6, 2020

Related U.S. Application Data
(60) Provisional application No. 62/870,660, filed on Jul. 3, 2019.

(51) Int. Cl. G06K 19/077; G06F 16/90

(52) U.S. Cl. CPC G06K 19/07758; G06F 16/90

(57) ABSTRACT

In use, a plurality of radio frequency identifier (RFID) tags are affixed to a plurality of food specimens. Additionally, in a database, the radio frequency identifier (RFID) tags are associated to a description of the plurality of food specimens. Further, the database is updated to reflect a status of one or more inspection processes in connection with the food specimens.

### CROSS-REFERENCES TO RELATED APPLICATIONS

The present application claims priority to and the benefit of U.S. Provisional Patent Application No. 62/870,660, titled “SYSTEM, METHOD, AND COMPUTER PROGRAM FOR TRACKING STATUS OF ONE OR MORE INSPECTION PROCESSES IN CONNECTION WITH FOOD SPECIMENS,” filed Jul. 3, 2019, which is hereby incorporated by reference for all purposes.

### FIELD OF THE INVENTION

The present invention relates to food specimen inspection process management, specifically, the efficient retrieval and tracking status of one or more food specimens by way of radio frequency transmission and reception.

### BACKGROUND

Large food inspection entities like the United States Department of Agriculture (USDA) inspection department(s) are required to inspect and oversee distribution of many, many tons of food specimens every day. Traditional methods involving batch or lot ID numbers and inspection result tabulation and reporting can take dozens or even hundreds of man hours to complete on a daily basis. A more efficient process of tracking inspection processes for hundreds and thousands of food specimens is needed to ensure that the resources available to the inspection department(s) in question are used as wisely and efficiently as possible. To this end, a radio transmission-based tracking system that may handle many hundreds of individual IDs and upload status information to a master database is essential to streamlining the ever-increasing volume of food specimen inspection processes.

As such, there is thus a need for addressing these and/or other issues associated with the prior art.

### SUMMARY

In use, a plurality of radio frequency identifier (RFID) tags are affixed to a plurality of food specimens. Additionally, in a database, the radio frequency identifier (RFID) tags are associated to a description of the plurality of food specimens. Further, the database is updated to reflect a status of one or more inspection processes in connection with the food specimens.

### BRIEF DESCRIPTION OF THE DRAWINGS

FIG. 1 illustrates a method for tracking status of one or more inspection processes in connection with food specimens, in accordance with one embodiment.

FIG. 2 illustrates a flow chart of the process involved in updating the status of one or more inspection processes associated with food specimens, in accordance with one embodiment.

FIG. 3 illustrates a table depicting plurality of radio frequency identifier (RFID) tags and their relative status associated with a plurality of food specimens, in accordance with one embodiment.

FIG. 4 illustrates a wireless communication system for determining and updating the status if a plurality of food specimens recorded in a database, in accordance with one embodiment.

FIG. 5 illustrates a network architecture, in accordance with one possible embodiment.

FIG. 6 illustrates an exemplary system, in accordance with one embodiment.

### DETAILED DESCRIPTION

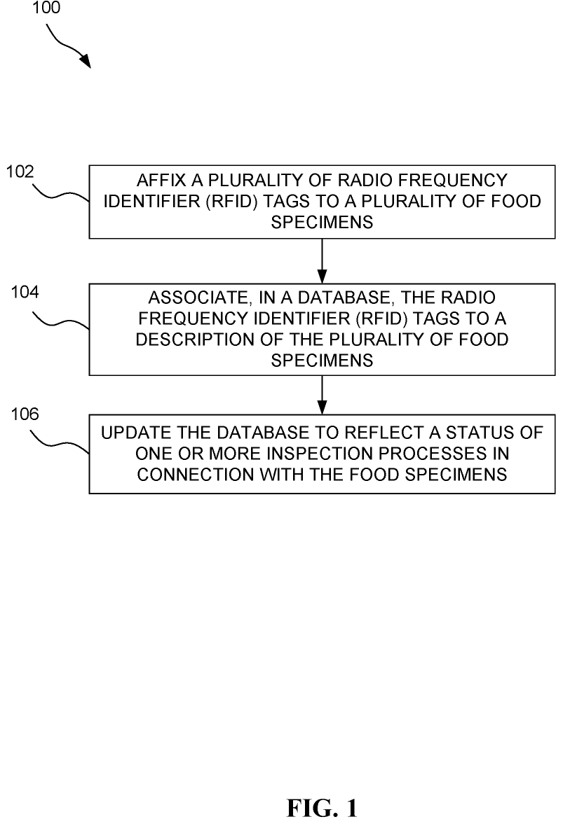

FIG. 1 illustrates a method 100 for tracking status of one or more inspection processes in connection with food specimens, in accordance with one embodiment.

As shown, a plurality of radio frequency identifier (RFID) tags are affixed to a plurality of food specimens. See operation 102. In one embodiment, RFID tags may be passive and/or battery powered (active). Additionally, RFID tags may be embedded with a transmitter and/or receiver device which may be comprised of a microchip and/or an antenna. Further, RFID tags may be read-only, wherein an assigned serial number may be used as a unique identifier in a database, or may be read/write, wherein specific data may be written into the tag by a user. Further still, field-programmable tags may be write-once, read-multiple, wherein “blank” tags may be assigned an electronic product code by the user.

Additionally, in a database, the radio frequency identifier (RFID) tags are associated to a description of the plurality of food specimens. See operation 104. In one embodiment, RFID tags may be embedded within the packaging of the food specimen or affixed to the external packaging of the specific food specimen with which the RFID is associated.

Further, the database is updated to reflect a status of one or more inspection processes in connection with the food specimens. See operation 106. In one embodiment, the status of the one or more inspection processes associated with specific food specimens may be detected by an RFID tag reader, which may be a handheld or other device that a user may employ to receive radio signals from RFID tags. In the context of the present description, a “reader” may be a two-way radio transmitter-receiver called an interrogator which may emit one or more signals to RFID tags in the vicinity and receive information within a response from the RFID tags and which may be used to update the system database with current food-inspection process status, or the reader may be a strictly “passive” receiver which only receives radio signals from battery-powered (active) tags. It should be noted that RFID tags may be a as near to the reader as just a couple of feet and/or many hundreds of feet away from the reader.

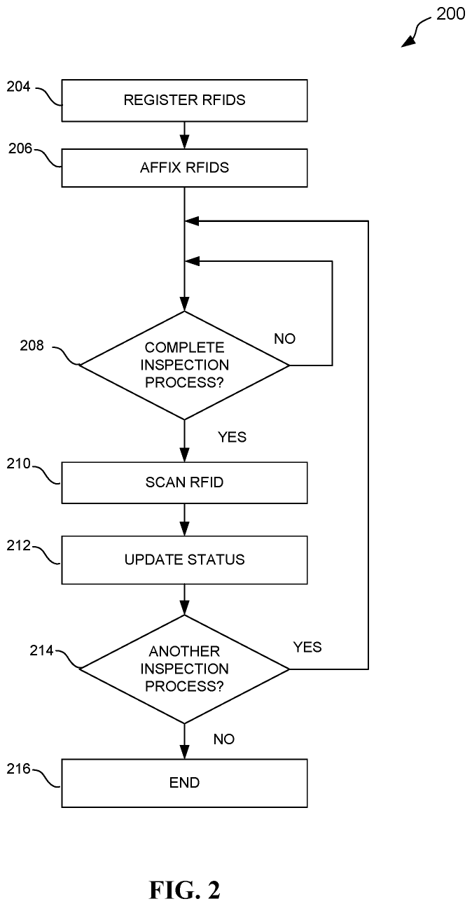

FIG. 2 illustrates a flow chart 200 of the process involved in updating the status of one or more inspection processes associated with food specimens, in accordance with one embodiment. As an option, the flow chart 200 may be implemented in the context of any one or more of the embodiments set forth in any previous and/or subsequent figure(s) and/or description thereof. Of course, however, the flow chart 200 may be implemented in the context of any desired environment. Further, the aforementioned definitions may equally apply to the description below.

In operation, a plurality of RFID tags associated with specific food specimens may be registered in an inspection process status database, wherein each individual RFID is associated with a specific food specimen which will pass through one or more food-inspection processes. See operation 204.

Additionally, each of the individual RFID tags may be physically affixed and/or packaged with a specific food specimen, as in operation 206. In one embodiment, an RFID tag may be affixed to the exterior of the food specimen packaging. In another embodiment, the RFID tag may be packaged with the food specimen in a manner such that both the food specimen and the RFID tag are enclosed together in an additional packaging format adequate to keep both the RFID tag and the associated food specimen essentially “affixed” to one another without the use of an adhesive compound.

Further, the inspection process status for one or more food specimens may be received by a reader and adjudged to be complete, thus requiring no further tracking by the system, or still in process, thus requiring additional polling for future status updates, as in decision point 208. If the inspection process is adjudged to be complete, the RFID tag status may be scanned by the reader as in operation 210 and the status updated in the database. See operation 212. If the inspection process is adjudged to be incomplete, the RFID tag status, which may require one or more additional status updates in the future, may be noted by the reader and the reader may return to seek further status from the RFID tag at an undetermined future time.

Further still, the reader may determine that one or more inspection processes associated with specific food specimens are complete and may then poll other RFID tags in an effort to determine whether further inspection processes are still in need of updates, as in decision point 214. If the reader determines that there are additional inspection processes for which status must be collected, the reader may return to decision point 208 in the process and may determine the current status of one or more food specimens for which the status remains incomplete and may continue to record additional status updates for incomplete inspection processes.

Finally, when it is determined by the reader that all of the inspection processes for the identifiable food specimens in range are complete per the RFID tag scan(s) implemented in operation 210, the reader updates the database with current status as in operation 212 and, identifying no more outstanding inspection processes in need of tracking, terminates the tracking and updating process. See operation 216.

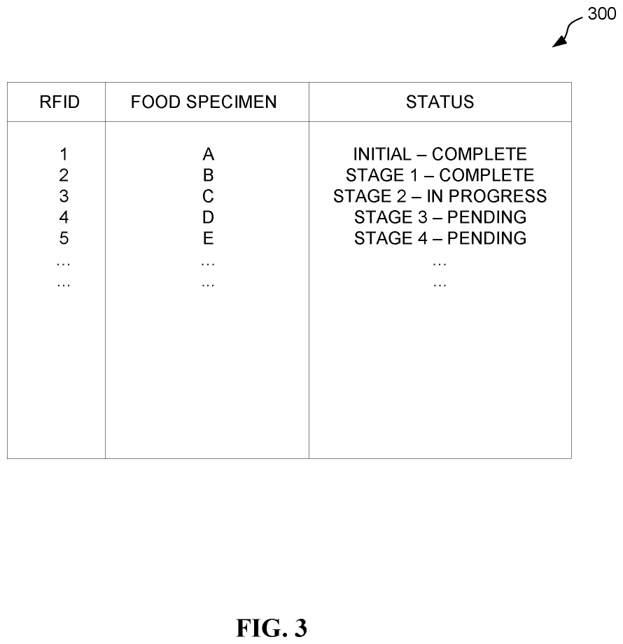

FIG. 3 illustrates a tabular screen display 300 depicting a plurality of radio frequency identifier (RFID) tags and their relative status associated with a plurality of food specimens, in accordance with one embodiment. As an option, the display 300 may be implemented in the context of any one or more of the embodiments set forth in any previous and/or subsequent figure(s) and/or description thereof. Of course, however, the display 300 may be implemented in the context of any desired environment. Further, the aforementioned definitions may equally apply to the description below.

It should be noted that the display 300 of the plurality of RFID tag identifiers, each RFID tag identifier's associated food specimen, and respective current status may be visible on the reader device and/or on an associated external screen that may be a visual media display component of a computer system and/or a remote display located in a location other than the location of the user and the RFID tag reader. Additionally, one or more stages and/or steps and their respective status designations may be assigned by the user according to a predetermined set of criteria and/or in an ad hoc manner as necessary to accurately reflect the current status of the plurality of food specimens within the inspection process(es). Further, the status designations visible in the display may include status updates such as “complete,” “finished,” “compliant,” “rejected,” “active,” “in process,” “pending,” and so forth.

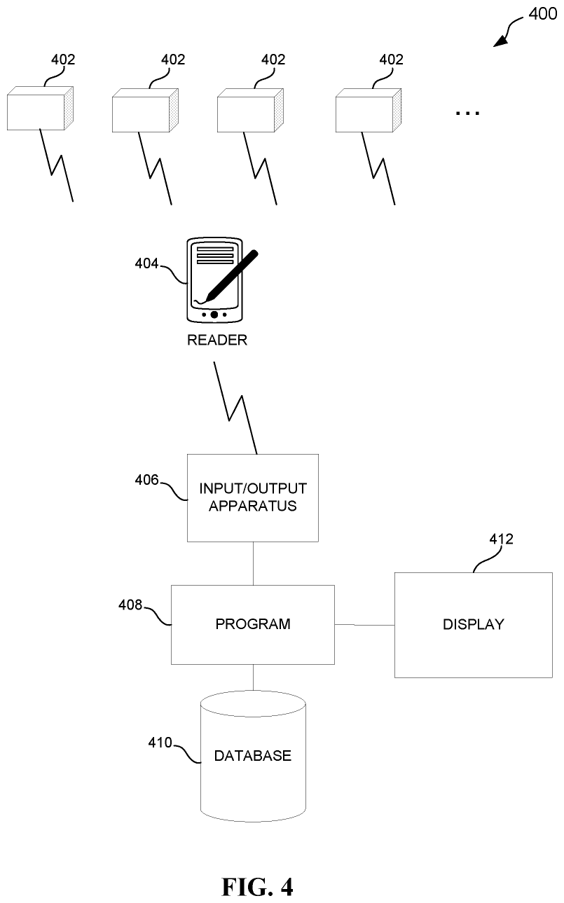

FIG. 4 illustrates a wireless communication system 400 for determining and updating the status if a plurality of food specimens recorded in a database, in accordance with one embodiment. As an option, the wireless communication system 400 may be implemented in the context of any one or more of the embodiments set forth in any previous and/or subsequent figure(s) and/or description thereof. Of course, however, the wireless communication system 400 may be implemented in the context of any desired environment. Further, the aforementioned definitions may equally apply to the description below.

In operation, the system 400 may track the status of one or more food specimens 402 by way of an RFID tag reader 404 transmitting a radio signal to one or more passive RFID tags and/or receiving a radio signal from one or more passive or active RFID tags and may retrieve status information about the associated food specimen's current inspection process stage and/or status.

Additionally, having collected status from one or more RFID tags associated with each individual food specimen 402, the reader 404 may transmit status update information to the tracking system 400 via an input-output apparatus designed to collect and interpret said status information for an attached database 410. It should be noted that the reader 404 may automatically upload/transmit status information to the input/output apparatus 406 at designated times and/or when a threshold amount of data has been collected, or status information may be uploaded manually upon appropriate input from the user at any time.

Further, the system 400 may update database 410 with current status of the inspection process status of one or more food specimens 402 recorded and uploaded by the reader 404. In one embodiment, the system 400 may update the database as often as status information is uploaded to the input/output apparatus 406 from the reader 404, or may be updated at frequent, or infrequent, intervals as a constant activity.

Further still, the system 400 may show current status information on one or more displays 412 so that accurate tracking information may be made available to the system 400 administrator/user. In one embodiment, the display 412 may show RFID, food specimen, and inspection process status information as described in display 300.

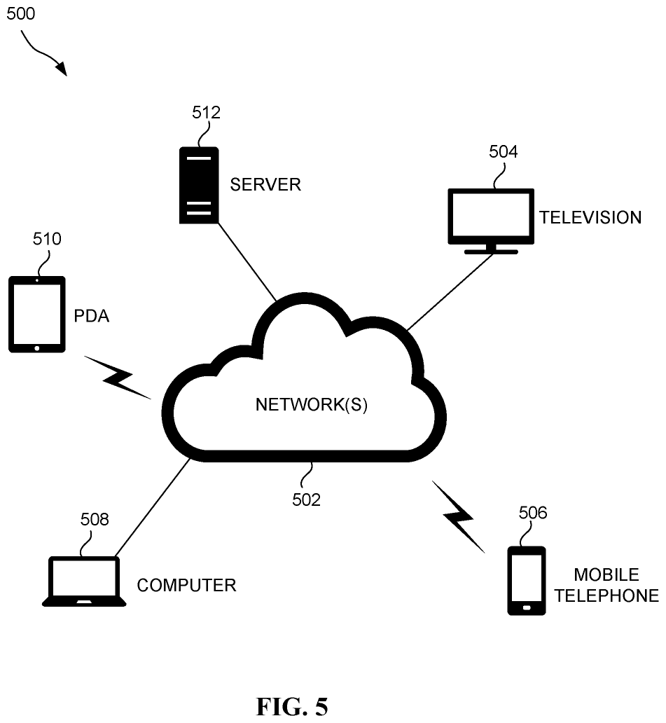

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 512 and an end user computer 508 may be coupled to the network 502 for communication purposes. Such end user computer 508 may include a desktop computer, lap-top computer, and/or any other type of logic. Still yet, various other devices may be coupled to the network 502 including a personal digital assistant (PDA) device 510, a mobile phone device 506, a television 504, etc.

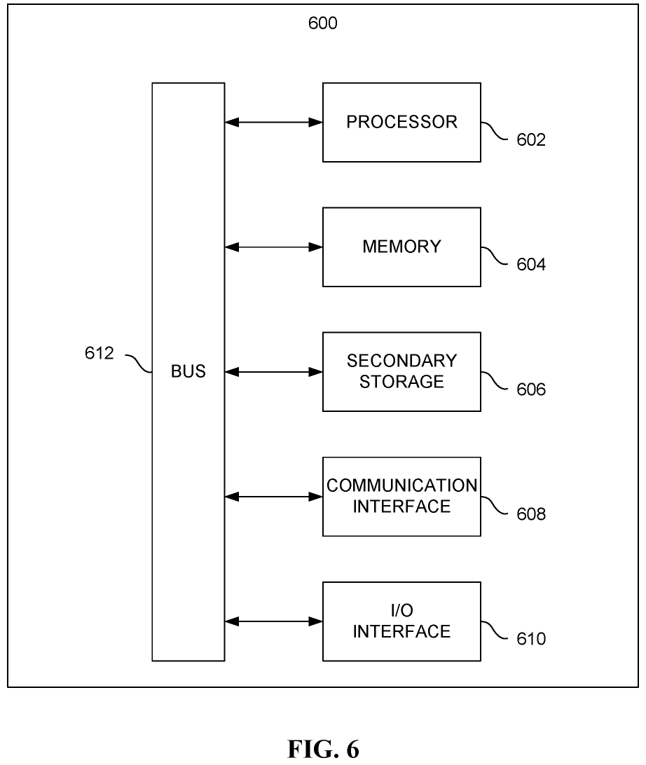

FIG. 6 illustrates an exemplary system 600, in accordance with one embodiment. As an option, the system 600 may be implemented in the context of any of the devices of the network architecture 500 of FIG. 5. Of course, the system 600 may be implemented in any desired environment.

As shown, a system 600 is provided including at least one central processor 602 which is connected to a communication bus 612. The system 600 also includes main memory 604 [e.g. random access memory (RAM), etc.]. The system 600 also includes a graphics processor 608 and a display 610.

The system 600 may also include a secondary storage 606. The secondary storage 606 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 604, the secondary storage 606, and/or any other memory, for that matter. Such computer programs, when executed, enable the system 600 to perform various functions (as set forth above, for example). Memory 604, storage 606 and/or any other storage are possible examples of non-transitory computer-readable media. It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method, comprising:
affixing a plurality of radio frequency identifier (RFID) tags to a plurality of food specimens;
associating, in a database, the radio frequency identifier (RFID) tags to a description of the plurality of food specimens; and
updating the database to reflect a status of one or more inspection processes in connection with the food specimens.
